(19) United States
(12) Patent Application Publication
(10) Pub. No.: US 2022/0390664 A1
(43) Pub. Date: Dec. 8, 2022

(54) DISPLAY DEVICE

(71) Applicant: OMRON Corporation, Kyoto-shi, KYOTO (JP)

(72) Inventors: Masafumi DANNO, Kyoto-shi (JP); Shizuto YUKUMOTO, Kyoto-shi (JP); Masayuki SHINOHARA, Kyoto-shi (JP); Norikazu KITAMURA, Kyoto-shi (JP)

(73) Assignee: OMRON Corporation, Kyoto-shi, KYOTO (JP)

(21) Appl. No.: 17/770,345

(22) PCT Filed: Oct. 23, 2020
(86) PCT No.: PCT/JP2020/039992

§ 371 Date: Apr. 20, 2022

(30) Foreign Application Priority Data
Nov. 25, 2019 (JP) 2019-211992

(51) Int. Cl. F21V 8/00; G02B 5/10

(52) U.S. Cl. CPC G02B 6/0055; G02B 6/0031; G02B 5/10; G02B 30/40

(57) ABSTRACT

A display device according to one or more embodiments may be provided with: a light guide plate that guides incident light and emits the light from a light exit surface; a half mirror disposed on the light-exit-surface side of the light guide plate; and a mirror disposed on the side opposite to the light exit surface of the light guide plate. The light guide plate may form an image accompanied by a change that is made in a direction from the half mirror toward the mirror in a space different from the light exit surface.

### TECHNICAL FIELD

The present invention relates to a display device that displays an image in a space.

### BACKGROUND ART

Patent Literature 1 discloses a display device provided with: a transparent light guide plate on which a display unit including a plurality of recesses is formed, the recesses each having a reflecting surface that reflects incident light toward the front surface side; a half-mirror plate disposed on the front surface side of the light guide plate; and a mirror plate disposed on the back surface side of the light guide plate. The display device multiply reflects light from a light source, the light having traveled in the light guide plate and reflected on the reflecting surface of each recess, between the half-mirror plate and the mirror plate to display multiple images of the display unit.

### PRIOR ART DOCUMENT

### Patent Document

Patent Document 1: Japanese Unexamined Patent Publication No. 2010-2635

### SUMMARY OF THE INVENTION

### Problems to be Solved by the Invention

However, the display device disclosed in Patent Document 1 can display only images of the display unit formed on the back surface of the light guide plate, that is, multiple images being planar images, and thus has a problem that designability is not sufficient.

An object of one aspect of the present invention is to provide a display device capable of providing a display with high taste and excellent design.

### Means for Solving the Problem

In order to solve the above problem, a display device according to one aspect of the present invention is provided with: a light guide plate configured to guide incident light, reflect the light by an optical path changing unit formed at a predetermined position, and emit the light from a light exit surface; a half mirror disposed on the light-exit-surface side of the light guide plate; and a mirror disposed on a side of the light guide plate opposite to the light exit surface. The light guide plate forms an image accompanied by a change that is made in a direction from the half mirror toward the mirror in a space different from the light exit surface by light emitted from the light exit surface.

### Effect of the Invention

According to one aspect of the present invention, it is possible to achieve a display device capable of providing a display with high taste and excellent design.

### BRIEF DESCRIPTION OF THE DRAWINGS

FIG. 1 is a view illustrating a configuration of a display device according to the embodiment.

FIG. 2 is a perspective view for describing a principle of a display by the display device according to the embodiment.

FIG. 3 is a view illustrating an example of an optical path in the display device according to the embodiment.

FIG. 4 is a view illustrating an example of an image displayed by a light guide plate included in the display device according to the embodiment.

FIG. 5 is a view illustrating examples of an image formed by the display device according to the embodiment.

FIG. 6 is a view illustrating a relationship of a distance between a half mirror and a mirror and an entire length of an image in the depth direction of the display device.

FIG. 7 is a perspective view illustrating examples of a game machine to which the display device according to the embodiment is applied.

FIG. 8 is a view illustrating a state where the display device according to the embodiment is applied to a tail lamp of a vehicle.

FIG. 9 is a view illustrating a display device according to a first modification.

FIG. 10 is a view illustrating a display device according to a second modification.

FIG. 11 is a view illustrating a light guide plate included in a display device according to a third modification.

FIG. 12 is a view illustrating a specific example of an image formed by the display device according to the third modification.

FIG. 13 is a view for describing a display device according to a fourth modification.

FIG. 14 is a view for describing a display device according to a fifth modification.

FIG. 15 is a view illustrating a display device according to a sixth modification.

FIG. 16 is a view illustrating a display device according to a seventh modification.

FIG. 17 is a view illustrating a display device according to an eighth modification.

FIG. 18 is a view illustrating a display device according to a ninth modification.

FIG. 19 is a view illustrating a display device according to a tenth modification.

FIG. 20 is a view illustrating a display device according to an eleventh modification.

FIG. 21 is a view illustrating a display device according to a twelfth modification.

FIG. 22 is a perspective view of a display device according to a thirteenth modification.

FIG. 23 is a cross-sectional view illustrating the configuration of the display device according to the thirteenth modification.

FIG. 24 is a plan view illustrating the configuration of the display device according to the thirteenth modification.

FIG. 25 is a perspective view illustrating a configuration of an optical path changing unit included in the display device according to the thirteenth modification.

FIG. 26 is a perspective view illustrating the arrangement of the optical path changing unit included in the display device according to the thirteenth modification.

FIG. 27 is a perspective view illustrating a method for formation of a stereoscopic image by the display device according to the thirteenth modification.

### MODE FOR CARRYING OUT THE INVENTION

[First Embodiment] Hereinafter, an embodiment according to one aspect of the present invention (hereinafter also referred to as “the embodiment”) will be described with reference to the drawings.

### § 1 Application Example

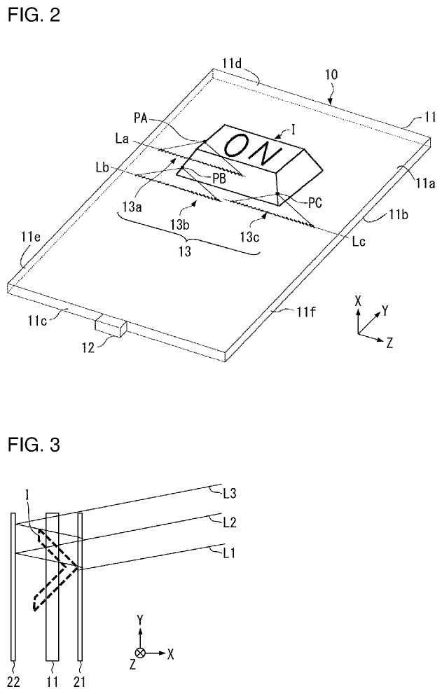

First, a principle of a display by the display device of the present invention will be described. In the following, for convenience of description, a +X direction in FIG. 2 may be described as a front direction, a −X direction as a back direction, a +Y direction as an up direction, a −Y direction as a down direction, a +Z direction as a right direction, and a −Z direction as a left direction.

FIG. 2 is a perspective view for describing a principle of a display by a display device 10. The display device 10 forms a stereoscopic image, visually recognized by a user, in a space without a screen. FIG. 2 illustrates a state where the display device 10 displays a stereoscopic image I, more specifically, a button-shaped stereoscopic image I, on which characters “ON” are displayed. FIG. 2 illustrates a light guide plate 11 and a light source 12 among constituent elements included in the display device 10.

The light guide plate 11 guides light incident from the light source 12 and emits the light from an outgoing surface 11a to form the image in a space. The light guide plate 11 has a rectangular parallelepiped shape and is formed of a resin material having transparency and a relatively high refractive index. A material forming the light guide plate 11 may be, for example, polycarbonate resin, polymethyl methacrylate resin, glass, or the like. The light guide plate 11 includes an outgoing surface 11a (light exit surface) that emits light, a back surface 11b on the opposite side to the outgoing surface 11a, and end faces 11c, 11d, 11e, and 11f that are four end faces. The end face 11c is an incident surface on which light projected from the light source 12 is incident on the light guide plate 11. The end face 11d is a surface on the opposite side to the end face 11c. The end face 11e is a surface on the opposite side to the end face 11f. The light guide plate 11 spreads and guides the light from the light source 12 on a plane parallel to the outgoing surface 11a. The light source 12 is, for example, a light-emitting diode (LED) light source.

On the back surface 11b of the light guide plate 11, a plurality of optical path changing units 13, which include an optical path changing unit 13a, an optical path changing unit 13b, and an optical path changing unit 13c, are formed. The optical path changing units 13 are formed substantially continuously in the Z-axis direction. In other words, the plurality of optical path changing units 13 are formed along respectively predetermined lines within a plane parallel to the outgoing surface 11a. Light projected from the light source 12 and guided by the light guide plate 11 is incident on each of the positions in the Z-axis direction of the optical path changing units 13. The optical path changing unit 13 substantially converges the light incident on each position of the optical path changing unit 13 to a definite point corresponding to each optical path changing unit 13. FIG. 2 particularly illustrates the optical path changing unit 13a, the optical path changing unit 13b, and the optical path changing unit 13c as some of the optical path changing units 13. Specifically, a state is illustrated where light emitted from each of the optical path changing unit 13a, the optical path changing unit 13b, and the optical path changing unit 13c converges.

Specifically, the optical path changing unit 13a corresponds to a definite point PA of the stereoscopic image I. Light from each position of the optical path changing unit 13a converges on the definite point PA. Thus, the wavefront of the light from the optical path changing unit 13a becomes a wavefront of light that is as if emitted from the definite point PA. The optical path changing unit 13b corresponds to a definite point PB on the stereoscopic image I. Light from each position of the optical path changing unit 13b converges on the definite point PB. As described above, the light from each position of the arbitrary optical path changing unit 13 substantially converges on the definite point corresponding to each optical path changing unit 13. Thereby, the arbitrary optical path changing unit 13 can provide a wavefront of light that is as if emitted from the corresponding definite point. The definite points corresponding to the respective optical path changing units 13 are different from each other, and the stereoscopic image I recognized by the user is formed on the space (more specifically, on the space on the outgoing surface 11a side from the light guide plate 11) by a collection of a plurality of definite points each corresponding to the optical path changing units 13.

As illustrated in FIG. 2, the optical path changing unit 13a, the optical path changing unit 13b, and the optical path changing unit 13c are formed along a line La, a line Lb, and a line Lc, respectively. Here, the line La, the line Lb, and the line

Lc are straight lines substantially parallel to the Z-axis direction. The arbitrary optical path changing unit 13 is formed substantially continuously along a straight line parallel to the Z-axis direction.

### § 2 Configuration Example

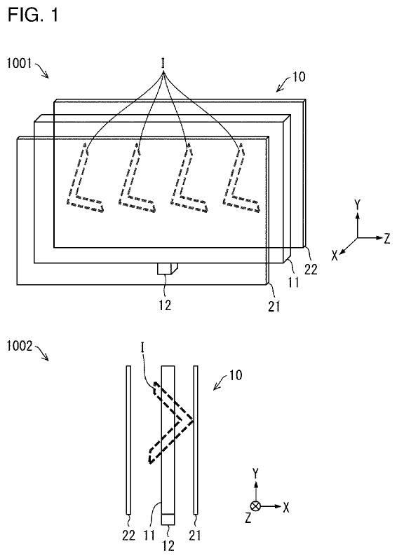

FIG. 1 is a view illustrating a specific configuration of the display device 10 according to the embodiment. In FIG. 1, a perspective view of the display device 10 is indicated by reference numeral 1001, and a side view thereof is indicated by reference numeral 1002. As illustrated in FIG. 1, the display device 10 includes a half mirror 21 and a mirror 22 in addition to the light guide plate 11 and the light source 12 described above.

The half mirror 21 is a half mirror that reflects a part of incident light and transmits the rest. The half mirror 21 is disposed on the outgoing surface 11a side of the light guide plate 11. The mirror 22 is a mirror that reflects incident light. The mirror 22 is disposed on the side of the light guide plate 11 opposite to the outgoing surface 11a.

The light transmittance of the half mirror 21 is preferably 80% or less. In the display device 10, blurring due to optical noise may occur in the image I formed. By setting the transmittance of the half mirror 21 to 80% or less, the optical noise is less likely to be visually recognized, and the visibility of the image I is improved. However, the light transmittance of each of the half mirror 21 and the mirror 22 may not necessarily be 80% or less.

FIG. 3 is a view illustrating an example of an optical path in the display device 10. A part of the light emitted from the outgoing surface 11a of the light guide plate 11 passes through the half mirror 21 and is emitted to the outside of the display device 10 as light L1. On the other hand, the light reflected by the half mirror 21 passes through the light guide plate 11, is reflected by the mirror 22, passes through the light guide plate 11 again, and reaches the half mirror 21 again. A part of the light having reached the half mirror 21 again is transmitted through the half mirror 21 and emitted to the outside of the display device 10 as light L2 along an optical path different from the light L1.

The light reflected again by the half mirror 21 is further emitted toward the half mirror 21 via the light guide plate 11, the mirror 22, and the light guide plate 11. In the example illustrated in FIG. 3, the light emitted from the light guide plate 11 toward the half mirror 21 for the third time passes through the outside of the half mirror 21 and is emitted to the outside as light L3. However, depending on the emission position of the first light, the number of times the light emitted from the outgoing surface 11a is reflected between the half mirror 21 and the mirror 22 may increase or decrease as compared with the example illustrated in FIG. 3.

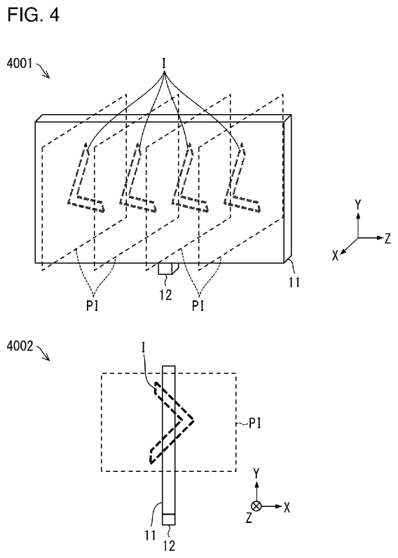

FIG. 4 is a view illustrating an example of the image I formed by the light guide plate 11 included in the display device 10. With the light emitted from the outgoing surface 11a, the light guide plate 11 forms the image I accompanied by a change that is made in a direction from the half mirror 21 toward the mirror 22 in a space different from the outgoing surface 11a. The image I is, for example, a planar image having an angle larger than 0° with respect to the outgoing surface 11a. In the example indicated by reference numerals 4001 and 4002 in FIG. 4, the image I formed by the light guide plate 11 is a planar image parallel to a plane PI perpendicular to the outgoing surface 11a. However, the image I may not be parallel to the plane PI perpendicular to the outgoing surface 11a. The image I may be a stereoscopic image.

The light guide plate 11 forms the image I so that the image I can be visually recognized when the eyes of the user are arranged in a perpendicular direction (lateral direction) to a direction (longitudinal direction) in which the light incident from the light source 12 is guided in the light guide plate 11. Note that the light guide plate 11 may form the image I so that the image I can be visually recognized when the eyes of the user are arranged not in the lateral direction but in the longitudinal direction or an oblique direction.

Further, in the example indicated by reference numerals 4001 and 4002 in FIG. 4, a plurality of images I are aligned in a direction orthogonal to the direction in which the light from the light source 12 is guided in the light guide plate 11. In the display device 10, the shape of the image I can be controlled by the direction of the reflecting surface of the optical path changing unit 13.

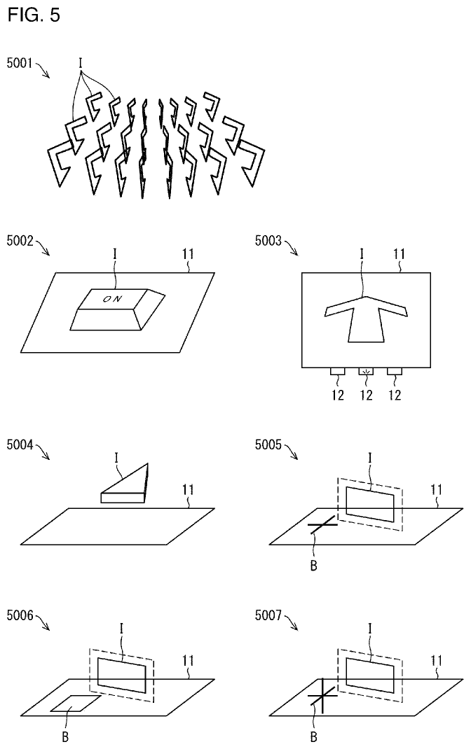

FIG. 5 is a view illustrating examples of the image I formed by the display device 10. As illustrated in FIG. 3, the light emitted from the outgoing surface 11a is repeatedly reflected between the half mirror 21 and the mirror 22. Therefore, when the display device 10 is visually recognized from the outgoing surface 11a side of the light guide plate 11, as indicated by reference numeral 5001 in FIG. 5, a plurality of images I formed in the space are formed side by side in the depth direction.

The image I may have a shape of a switch protruding from the light guide plate 11 as indicated by reference numeral 5002 in FIG. 5. The image I may have a shape of an arrow directed toward the light guide plate 11 as indicated by reference numeral 5003 in FIG. 5. The image I may have a shape of a triangular prism separated from the light guide plate 11 as indicated by reference numeral 5004 in FIG. 5.

The image I may be a rectangle on a plane not parallel to the light guide plate 11 as indicated by reference numerals 5005 to 5007 in FIG. 5. In this case, an image B serving as a reference for visually recognizing the image I may be further displayed. The image B may be two-dimensional coordinate axes as indicated by reference numeral 5005 in FIG. 5. The image B may be a plane on the light guide plate 11 as indicated by reference numeral 5006 in FIG. 5. The image B may be three-dimensional coordinate axes as indicated by reference numeral 5007 in FIG. 5.

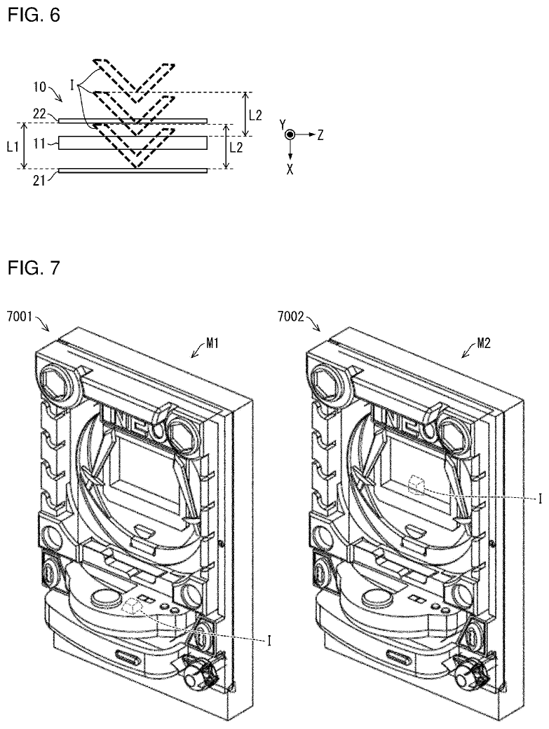

FIG. 6 is a view illustrating a relationship of a distance between the half mirror 21 and the mirror 22 and an entire length of an image I in the depth direction of the display device 10. As illustrated in FIG. 6, the distance between the half mirror 21 and the mirror 22 is L1, and the entire length of the image I in the depth direction of the display device 10 is L2.

When L2 is larger than twice L1, the multiply formed images I by the display device 10 have regions overlapping with each other. In this case, it is possible to make an expression as if the multiply formed images I were a single image continuous in the depth direction. On the other hand, when L2 is equal to or less than twice L1, the multiply formed images I by the display device 10 do not have regions overlapping with each other. In this case, it is possible to make an expression as if many images I were gathered.

### § 3 Operation Examples

FIG. 7 is a perspective view illustrating examples of a game machine to which the display device 10 is applied. In FIG. 7, the display device 10 is not illustrated. The display device 10 can be applied to an input device to be used in a device for amusement, such as a game machine. The input device includes the display device 10 and a sensor that detects the presence or absence of an object at a position of an image displayed by the display device 10. When the user performs an input operation on the image displayed by the display device 10 with an indicator such as his or her finger, the sensor detects the indicator, and the input device receives the input.

As indicated by reference numeral 7001 in FIG. 7, in an operation panel operated by the user on a game machine M1, the display device 10 may form the stereoscopic image I as at least one of a plurality of switches operated by the user. As indicated by reference numeral 7002 in FIG. 7, the display device 10 may form the stereoscopic image I as a switch that is formed to be superimposed on the screen on which a performance image for the user is displayed in a game machine M2, the switch being operated by the user. In this case, the display device 10 may display the stereoscopic image I only when the display is necessary for performance. The display device 10 may be applied to a game machine not as an input device but as a display device that displays an image for performance. The display device 10 may be applied as an illumination provided on a frame or the like of a game machine installed in a casino or the like.

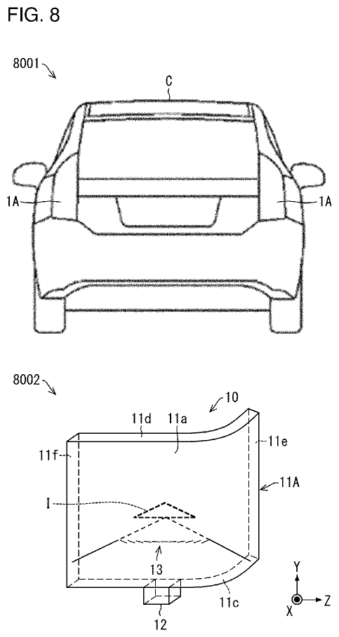

FIG. 8 is a view illustrating a state where the display device 10 is applied to a tail lamp of a vehicle C. The display device 10 can be applied to a tail lamp 1 A of the vehicle C, for example, as indicated by reference numeral 8001 in FIG. 8. In this case, the display device 10 includes a light guide plate 11A and the light source 12 as indicated by reference numeral 8002 in FIG. 8. The light guide plate 11A is different from the light guide plate 11 in that the light guide plate has a curved shape in accordance with the shape of the vehicle C. The optical path of the light incident from the light source 12 is changed by the optical path changing unit 13 formed in the light guide plate 11A, whereby the stereoscopic image I is displayed. The display device 10 may be applied to a vehicle lamp other than the tail lamp or a vehicle display device.

### § 4 Modifications

Although the embodiments of the present invention have been described in detail above, the above description is merely an example of the present invention in all respects. It goes without saying that various improvements and modifications can be made without departing from the scope of the present invention. For example, the following modifications are possible. Hereinafter, the same reference numerals are used for the same constituent elements as those in the above embodiment, and the same description as in the above embodiment is omitted as appropriate. The following modifications can be combined as appropriate.

<4.1>

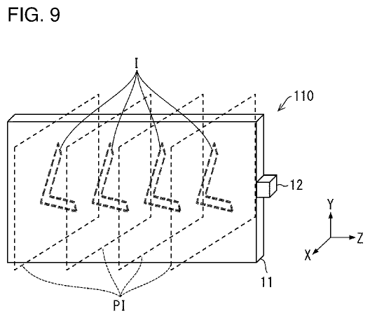

FIG. 9 is a view illustrating a display device 110 according to a first modification. For simplicity, the half mirror 21 and the mirror 22 are omitted in FIG. 9. In the display device 10 illustrated in FIG. 1, the plurality of images I have been aligned in the direction orthogonal to the direction in which the light from the light source 12 is guided in the light guide plate 11. In contrast, in the display device 110 illustrated in FIG. 9, a plurality of images I are formed to be arranged in the same direction as the direction in which the light from the light source 12 is guided through the light guide plate 11. In the display device 110, the width of the light guide plate 11 viewed from the light source 12 is narrower than that of the display device 10. Therefore, in the display device 110, the light incident on the light guide plate 11 from the light source 12 is appropriately collimated, and the shape of the image I is controlled in accordance with the direction of the reflecting surface of the optical path changing unit 13.

<4.2>

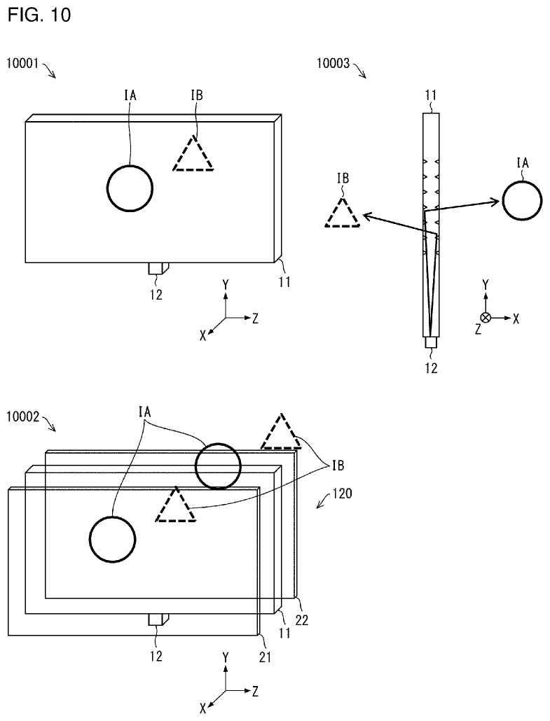

FIG. 10 is a view illustrating a display device 120 according to a second modification. In the display device 120, there is a difference in the image formed by the light guide plate 11 between the image formed on the half mirror 21 side of the outgoing surface 11a and the image formed on the mirror 22 side of the outgoing surface 11a. For example, as indicated by reference numeral 10001 in FIG. 10, the light guide plate 11 forms an image IA on the front side of the paper surface with respect to the light guide plate 11 and forms an image IB on the back side of the paper surface with respect to the light guide plate 11. Thus, as indicated by reference numeral 10002 in FIG. 10, the display device 120 forms a plurality of images IA on the half mirror 21 side with respect to the light guide plate 11 and forms a plurality of images IB on the mirror 22 side with respect to the light guide plate 11. Therefore, it is possible to display an image that changes between the front side and the back side of the light guide plate 11 in the depth direction. In the display device 120, the images IA, IB may be planar images displayed on the front surface and the back surface of the light guide plate 11, respectively, as indicated by reference numeral 10003 in FIG. 10.

<4.3>

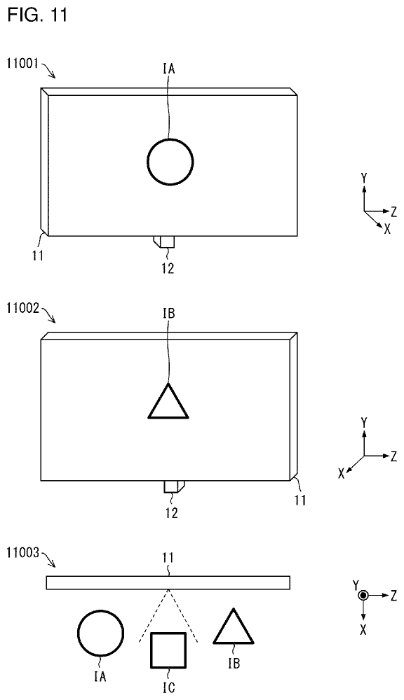

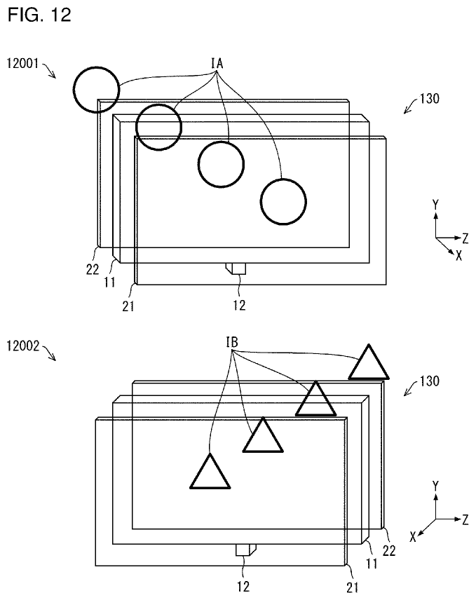

FIG. 11 is a view illustrating the light guide plate 11 included in a display device 130 (cf. FIG. 12) according to a third modification. In the display device 130, an image formed by the light guide plate 11 differs depending on a direction in which the image is formed. The light guide plate 11 in the display device 130 forms a different image IA, IB, or IC depending on the direction in which the image is formed as indicated by reference numerals 11001, 11002, and 11003 in FIG. 11, for example.

FIG. 12 is a view illustrating a specific example of the image formed by the display device 130. As indicated by reference numeral 12001 in FIG. 12, the display device 130 forms a plurality of images IA in a direction in which the light guide plate 11 forms the image IA. On the other hand, as indicated by reference numeral 12002 in FIG. 12, the display device 130 forms a plurality of images IB in a direction in which the light guide plate 11 forms the image IB. It is thus possible to multiply form different images depending on the direction in which the user views the display device 130.

<4.4>

FIG. 13 is a view for describing a display device 140 according to a fourth modification. For simplicity, the half mirror 21 and the mirror 22 are omitted in FIG. 13. In the display device 140, the images I formed by the light guide plate 11 have a shape of convergence on the side where the mirror 22 is disposed with respect to the light guide plate 11. For example, as indicated by reference numeral 13001 in FIG. 13, the light guide plate 11 included in the display device 140 forms a plurality of images I. The plurality of images I have a design in which the images I converge on a predetermined vanishing point V.

Therefore, as indicated by reference numeral 13002 in FIG. 13, images formed by the display device 140 also have a design in which the images converge on the predetermined vanishing point. Therefore, according to the display device 140, it is possible to emphasize the stereoscopic effect of the images I.

In the light guide plate 11 included in the display device 140, the plurality of images I need not necessarily have the design toward a predetermined vanishing point, but may have, for example, a design in which the images I converge on a predetermined vanishing line.

<4.5>

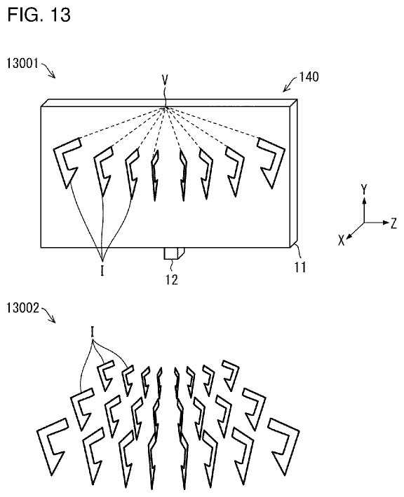

FIG. 14 is a view for describing a display device 150 according to a fifth modification. For simplicity, the half mirror 21 and the mirror 22 are omitted in FIG. 14. As indicated by reference numeral 14001 in FIG. 14, the light guide plate 11 included in the display device 150 forms an image ID parallel to the outgoing surface 11a in addition to the plurality of images I.

In the multiply formed images by the display device 150, the plurality of images I and images ID parallel to the outgoing surface 11a are formed multiply as indicated by reference numeral 14002 in FIG. 14. At this time, a plane on which the image ID is formed serves as a reference plane in the case of visually recognizing the images I. Therefore, according to the display device 150, it is possible to emphasize the stereoscopic effect of the images I.

<4.6>

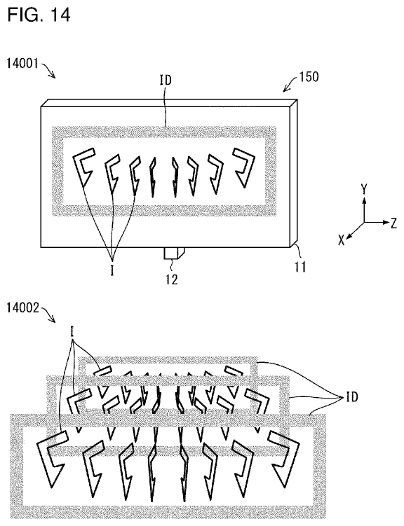

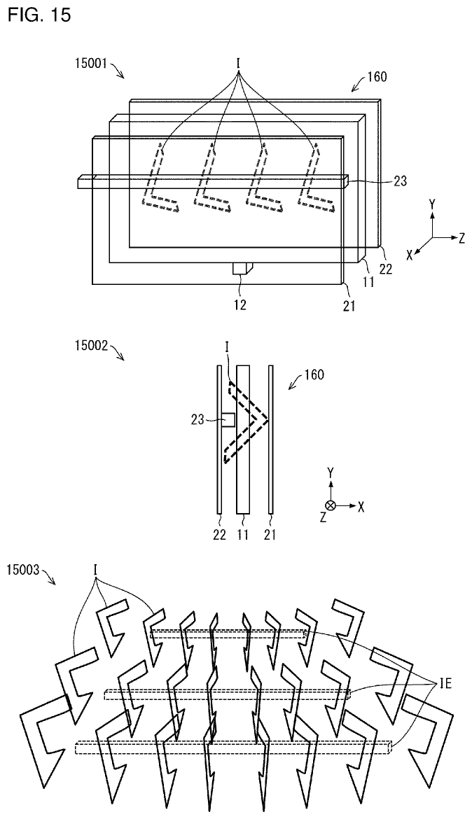

FIG. 15 is a view illustrating a display device 160 according to a sixth modification. As indicated by reference numerals 15001 and 15002 in FIG. 15, the display device 160 further includes a light emitting member 23 in addition to the configuration of the display device 10. The light emitting member 23 has a predetermined shape and emits light. The light emitting member 23 is provided in a region between the half mirror 21 and the mirror 22. The light emitting member 23 may include, for example, a light source and a light guide plate for a light emitting member. The light emitting member 23 may be a plurality of LEDs arranged in a predetermined shape.

In images multiply formed by the display device 160, the images I and images IE of the light emitting member 23 are formed multiply as indicated by reference numeral 15003 in FIG. 15. At this time, the position of the image IE of the light emitting member 23 serves as a reference position in the case of visually recognizing the images I. Therefore, according to the display device 160, it is possible to emphasize the stereoscopic effect of the images I.

<4.7>

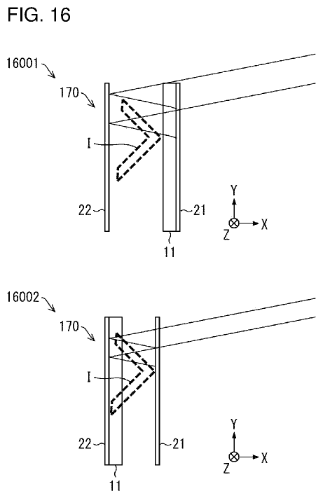

FIG. 16 is a view illustrating a display device 170 according to a seventh modification. In the display device 170, one of the half mirror 21 and the mirror 22 is formed on the front surface of the light guide plate 11. In an example indicated by reference numeral 16001 in FIG. 16, the half mirror 21 is deposited on the front surface of the light guide plate 11. In this case, the display device 170 multiply forms the images I only on the mirror 22 side. In an example indicated by reference numeral 16002 in FIG. 16, the mirror 22 is deposited on the front surface of the light guide plate 11. In this case, the display device 170 multiply forms the images I only on the half mirror 21 side.

One of the half mirror 21 and the mirror 22 may be formed on the front surface of the light guide plate 11 by a method other than vapor deposition. In the display device 170, the number of components and the space of the display device 170 can be reduced by forming the half mirror 21 or the mirror 22 on the front surface of the light guide plate 11.

<4.8>

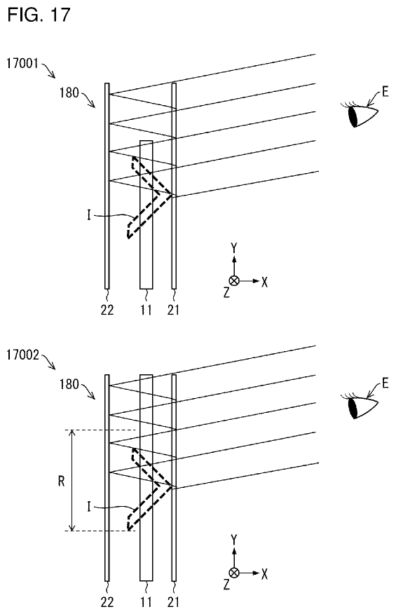

FIG. 17 is a view illustrating a display device 180 according to an eighth modification. As indicated by reference numeral 17001 in FIG. 17, in the display device 180, the half mirror 21 and the mirror 22 are longer than the light guide plate 11 in a direction parallel to the light guide plate 11. Thus, in the display device 180, the light emitted from the light guide plate 11 is repeatedly reflected in a wider range than the light guide plate 11 in a direction parallel to the front surface of the light guide plate 11 to form the image I. Therefore, according to the display device 180, as indicated by reference numeral 17001 in FIG. 17, even when a viewpoint E of the user is farther from the center of the light guide plate 11 than from the end of the light guide plate 11 in the direction parallel to the light guide plate 11, it is possible to give a sense of depth to the multiply formed images I.

However, in the display device 180, as indicated by reference numeral 17002 in FIG. 17, the half mirror 21 and the mirror 22 only needs to be longer than the length of a region R where the optical path changing unit 13 is provided in the direction parallel to the light guide plate 11. Such a display device 180 can also give a sense of depth to the multiply formed images I when the viewpoint E of the user is farther from the center of the light guide plate 11 than from the end of the light guide plate 11 in the direction parallel to the light guide plate 11.

<4.9>

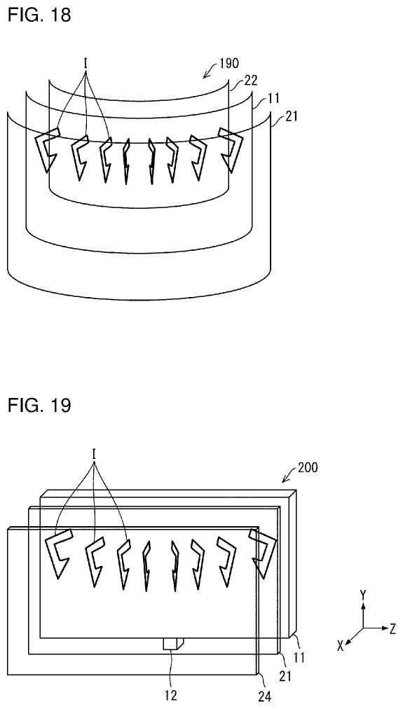

FIG. 18 is a view illustrating a display device 190 according to a ninth modification. For simplicity, the light source 12 is omitted in FIG. 18. As illustrated in FIG. 18, in the display device 190, the light guide plate 11, the half mirror 21, and the mirror 22 are curved so as to be convex toward the side where the images I are observed. According to such a display device 190, it is possible to form a plurality of curved images I.

<4.10>

FIG. 19 is a view illustrating a display device 200 according to a tenth modification. For simplicity, the mirror 22 is omitted in FIG. 19. As illustrated in FIG. 19, in addition to the configuration of the display device 10, the display device 200 further includes a cover 24 that transmits at least a part of the incident light on the side of the half mirror 21 opposite to the light guide plate 11. In the display device 200, the light transmittance of the half mirror 21 is lower than the light transmittance of the cover 24.

As described above, in the display device 10, blurring due to optical noise may occur in the image I formed. In the display device 200, with the provision of the cover 24, the optical noise is less likely to be visually recognized, thereby improving the visibility of the image I.

<4.11>

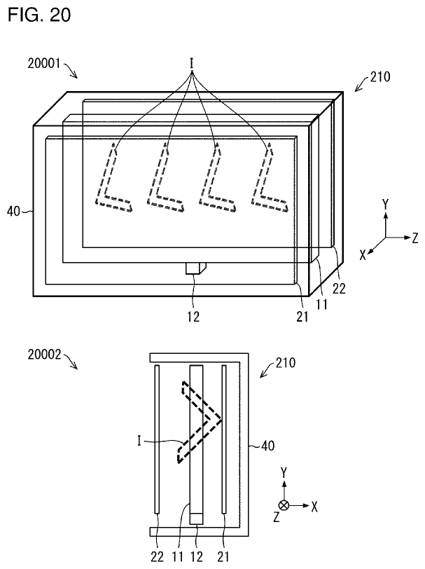

FIG. 20 is a view illustrating a display device 210 according to an eleventh modification. The display device 210 is applicable to, for example, a rear combination lamp of a vehicle. As indicated by reference numerals 20001 and 20002 in FIG. 20, the display device 210 further includes an inner cover 40 in addition to the configuration of the display device 10. By applying the display device 210 to the rear combination lamp, it is possible to achieve a rear combination lamp capable of forming a deep image while saving space.

<4.12>

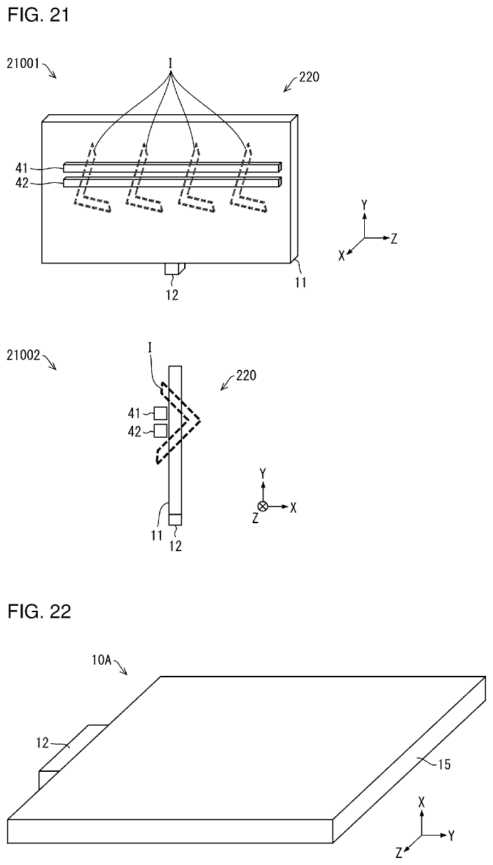

FIG. 21 is a view illustrating a display device 220 according to a twelfth modification. For simplicity, the half mirror 21 and the mirror 22 are omitted in FIG. 21. As indicated by reference numerals 21001 and 21002 in FIG. 21, the display device 220 includes a blinker 41 and a brake lamp 42 in addition to the configuration of the display device 10. In other words, the display device 220 has a configuration in which the blinker 41 and the brake lamp 42 are superimposed on the light guide plate 11.

In the display device 220, in addition to the images I, light during the operation of the blinker 41 and/or the brake lamp 42 is formed multiply. Therefore, according to the display device 220, it is possible to achieve a vehicle lamp with high taste also for each of the blinker 41 and the brake lamp 42.

In the display device 220, the blinker 41 and the brake lamp 42 are disposed, for example, between the light guide plate 11 and the mirror 22. In the display device 220, the blinker 41 and the brake lamp 42 may be disposed between the light guide plate 11 and the half mirror 21. However, in the display device 220, the blinker 41 and the brake lamp 42 may not necessarily be disposed on the same side with respect to the light guide plate 11. In addition, the display device 220 need not necessarily include both the blinker 41 and the brake lamp 42 but may include only one.

<4.13>

A display device 10A as a thirteenth modification will be described with reference to FIGS. 22 to 27.

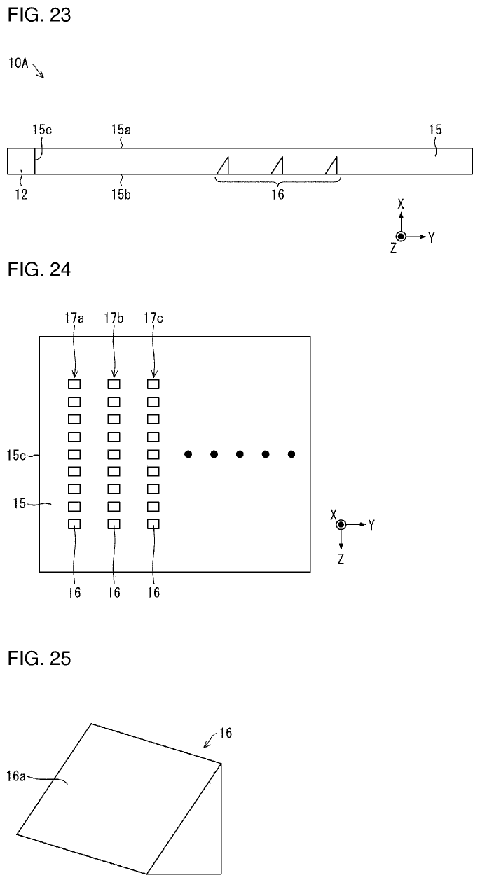

FIG. 22 is a perspective view of the display device 10A. FIG. 23 is a cross-sectional view illustrating the configuration of the display device 10A. FIG. 24 is a plan view illustrating the configuration of the display device 10A. FIG. 25 is a perspective view illustrating a configuration of an optical path changing unit 16 included in the display device 10A.

As illustrated in FIGS. 22 and 23, the display device 10A includes the light source 12 and a light guide plate 15 (first light guide plate).

The light guide plate 15 is a member that guides light (incident light) incident from the light source 12. The light guide plate 15 is formed of a transparent resin material having a relatively high refractive index. As a material for forming the light guide plate 15, for example, polycarbonate resin, polymethyl methacrylate resin, or the like can be used. In the modification, the light guide plate 15 is molded with polymethyl methacrylate resin. As illustrated in FIG. 23, the light guide plate 15 includes an outgoing surface 15a (light exit surface), a back surface 15b, and an incident surface 15c.

The outgoing surface 15a is a surface that emits light guided inside the light guide plate 15 and changed in its optical path by an optical path changing unit 16 to be described later. The outgoing surface 15a constitutes the front surface of the light guide plate 15. The back surface 15b is a surface parallel to the outgoing surface 15a and is a surface on which the optical path changing unit 16 to be described later is disposed. The incident surface 15c is a surface on which the light emitted from the light source 12 enters the light guide plate 15.

The light emitted from the light source 12 and incident on the light guide plate 15 from the incident surface 15c is totally reflected by the outgoing surface 15a or the back surface 15b and guided in the light guide plate 15.

As illustrated in FIG. 23, the optical path changing unit 16 is a member that is formed on the back surface 15b inside the light guide plate 15, changes the optical path of the light guided in the light guide plate 15, and emits the light from the outgoing surface 15a. A plurality of optical path changing units 16 are provided on the back surface 15b of the light guide plate 15.

As illustrated in FIG. 24, the optical path changing units 16 are provided along a direction parallel to the incident surface 15c. As illustrated in FIG. 25, the optical path changing unit 16 has a triangular pyramid shape and includes a reflecting surface 16a that reflects (totally reflects) incident light. The optical path changing unit 16 may be, for example, a recess formed in the back surface 15b of the light guide plate 15. The optical path changing unit 16 is not limited to the triangular pyramid shape. As illustrated in FIG. 24, a plurality of optical path changing unit groups 17a, 17b, 17c, . . . each made up of a plurality of optical path changing units 16 are formed on the back surface 15b of the light guide plate 15.

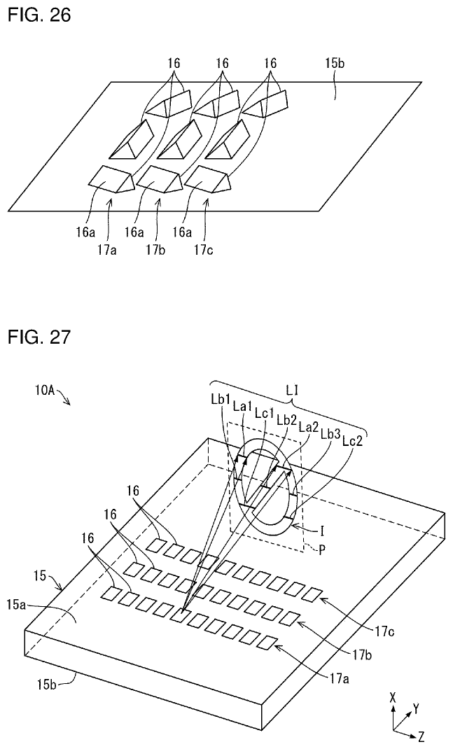

FIG. 26 is a perspective view illustrating the arrangement of the optical path changing units 16. As illustrated in FIG. 26, in each of the optical path changing unit groups 17a, 17b, 17c, . . . , the reflecting surfaces 16a of the plurality of optical path changing units 16 are arranged on the back surface 15b of the light guide plate 15 such that the angles with respect to the incident direction of light are different from each other. Thereby, each of the optical path changing unit groups 17a, 17b, 17c, . . . changes the optical path of the incident light and emits the incident light from the outgoing surface 15a in various directions.

Next, a method for formation of the stereoscopic image I by the display device 10A will be described with reference to FIG. 27. Here, a case will be described in which the stereoscopic image I as a plane image is formed on a stereoscopic image formed plane P, which is a plane perpendicular to the outgoing surface 15a of the light guide plate 15, by the light changed in its optical path by the optical path changing unit 16.

FIG. 27 is a perspective view illustrating the method for formation of the stereoscopic image I by the display device 10A. Here, the formation of a ring mark with a diagonal line as the stereoscopic image I on the stereoscopic image formed plane P will be described.

In the display device 10A, as illustrated in FIG. 27, for example, the light changed in its optical path by each optical path changing unit 16 of the optical path changing unit group 17a intersects with the stereoscopic image formed plane P on each of a line La1 and a line La2. Thereby, a line image LI which is a part of the stereoscopic image I is formed on the stereoscopic image formed plane P. The line image LI is a line image parallel to the YZ plane. In this manner, the line image LI of the line La1 and the line La2 is formed by the light from each of many optical path changing units 16 belonging to the optical path changing unit group 17a. Note that the light for forming the images of the lines La1, La2 only needs to be provided by at least two optical path changing units 16 in the optical path changing unit group 17a.

Likewise, the light changed in its optical path by each optical path changing unit 16 of the optical path changing unit group 17b intersects with the stereoscopic image formed plane P on each of lines Lb1, Lb2, and Lb3. Thereby, a line image LI which is a part of the stereoscopic image I is formed on the stereoscopic image formed plane P.

The light changed in its optical path by each optical path changing unit 16 of the optical path changing unit group 17c intersects with the stereoscopic image formed plane P on each of lines Lc1 and Lc2. Thereby, a line image LI which is a part of the stereoscopic image I is formed on the stereoscopic image formed plane P.

The positions in the X-axis direction of the line images LI formed by the optical path changing unit groups 17a, 17b, 17c, . . . are different from each other. In the display device 10A, by reducing the distance between the optical path changing unit groups 17a, 17b, 17c, . . . , the distance in the X-axis direction of the line image LI formed by each of the optical path changing unit groups 17a, 17b, 17c, . . . can be reduced. As a result, the display device 10A accumulates the plurality of line images LI formed by the light changed in its optical path by each of the optical path changing units 16 of the optical path changing unit groups 17a, 17b, 17c, . . . , thereby substantially forming the stereoscopic image I, which is a plane image, on the stereoscopic image formed plane P.

Note that the stereoscopic image formed plane P may be a plane perpendicular to the X-axis, a plane perpendicular to the Y-axis, or a plane perpendicular to the Z-axis. Further, the stereoscopic image formed plane P may be a plane that is not perpendicular to the X-axis, the Y-axis, or the Z-axis. Moreover, the stereoscopic image formed plane P may be a curved plane instead of a flat plane. That is, the display device 10A can cause the optical path changing unit 16 to form the stereoscopic image I on an arbitrary plane (flat plane and curved plane) on the space. By combining a plurality of plane images, a three-dimensional image can be formed.

<4.14>

The display device 10 may separately form images for a plurality of viewpoints. For example, the display device 10 may include a right-eye display pattern for forming a right-eye image and a left-eye display pattern for forming a left-eye image. In this case, the display device 10 can form an image having a stereoscopic effect. The display device 10 may separately form images for three or more viewpoints.

### SUMMARY

A display device according to one aspect of the present invention is provided with: a light guide plate configured to guide incident light, reflect the light by an optical path changing unit formed at a predetermined position, and emit the light from a light exit surface; a half mirror disposed on the light-exit-surface side of the light guide plate; and a mirror disposed on a side of the light guide plate opposite to the light exit surface. The light guide plate forms an image accompanied by a change that is made in a direction from the half mirror toward the mirror in a space different from the light exit surface by light emitted from the light exit surface.

With the above configuration, the image formed by the light guide plate is repeatedly reflected between the half mirror and the mirror. Therefore, when viewed from the light-exit-surface side of the light guide plate, it is possible to display multiple images in which a plurality of images formed in the space are arranged in the depth direction. Here, the image formed in the space is an image accompanied by a change that is made in a direction from the half mirror toward the mirror. By such an image becoming multiple images displayed further in the depth direction, it is possible to provide a display with high taste and excellent design.

In the display device according to one aspect of the present invention, when a distance between the half mirror and the mirror is L1, and an entire length of an image formed by the light guide plate in a direction from the half mirror toward the mirror is L2, L2 may be larger than twice L1.

With the above configuration, the multiply formed images have regions overlapping with each other. It is thus possible to make an expression as if the multiply formed images were a single image continuous in the depth direction.

In the display device according to one aspect of the present invention, when a distance between the half mirror and the mirror is L1, and an entire length of an image formed by the light guide plate in a direction in which the mirror is disposed is L2, L2 may be twice L1 or less.

With the above configuration, the multiply formed images do not have regions overlapping with each other. Therefore, by multiply forming images, it is possible to make an expression as if many images were gathered.

In the display device according to one aspect of the present invention, there may be a difference in an image formed by the light guide plate between an image formed on the side of the half mirror with respect to the light exit surface and an image formed on the side of the mirror with respect to the light exit surface.

With the above configuration, it is possible to display an image that changes between the front side and the back side of the light guide plate in the depth direction.

In the display device according to one aspect of the present invention, an image formed by the light guide plate may differ depending on a direction in which the image is formed.

With the above configuration, it is possible to display an image that changes depending on the direction in which the display device is viewed.

In the display device according to one aspect of the present invention, images formed by the light guide plate may have a shape of convergence on a side where the mirror is disposed with respect to the light guide plate.

With the above configuration, the multiply formed images also have a shape of convergence on the side where the mirror is disposed with respect to the light guide plate, so that it is possible to emphasize the stereoscopic effect of the image.

In the display device according to one aspect of the present invention, the mirror and the half mirror may be longer than a region where the optical path changing unit is provided in a direction parallel to the light guide plate.

With the above configuration, even when the viewpoint of the user is farther from the center of the light guide plate than from the end of the light guide plate, it is possible to give a sense of depth to the multiply formed images.

In the display device according to one aspect of the present invention, the mirror and the half mirror may be longer than the light guide plate in the direction parallel to the light guide plate.

With the above configuration, even when the viewpoint of the user is farther from the center of the light guide plate than from the end of the light guide plate, it is possible to give a sense of depth to the multiply formed images.

In the display device according to one aspect of the present invention, one of the half mirror and the mirror may be formed on the front surface of the light guide plate.

With the above configuration, it is possible to reduce the number of components and the space of the display device.

In the display device according to one aspect of the present invention, the light guide plate, the half mirror, and the mirror may be curved so as to be convex toward a side where the image is observed.

With the above configuration, it is possible to multiply form curved images.

In the display device according to one aspect of the present invention, the light transmittance of the half mirror may be 80% or less.

With the above configuration, optical noise is less likely to be visually recognized, and the visibility of the image is improved.

The display device according to one aspect of the present invention may further include a cover disposed on the side of the half mirror opposite to the light guide plate, and the light transmittance of the half mirror may be lower than a light transmittance of the cover.

With the above configuration, optical noise is less likely to be visually recognized, and the visibility of the image is improved.

The present invention is not limited to each of the embodiments described above but can be subjected to a variety of changes in the scope described in the claims. An embodiment obtained by appropriately combining technical means disclosed in each of different embodiments is also included in a technical scope of the present invention.

### DESCRIPTION OF SYMBOLS

10, 110, 120, 130, 140, 150, 160, 170, 180, 190, 200, 210, 220, 10A display device

11 light guide plate

11a outgoing surface (light exit surface)

12 light source

21 half mirror

22 mirror

24 cover

1. A display device comprising:
a light guide plate configured to guide incident light, reflect the light by an optical path changing unit formed at a predetermined position, and emit the light from a light exit surface;
a half mirror disposed on a side of the light exit surface of the light guide plate; and
a mirror disposed on a side of the light guide plate opposite to the light exit surface,
wherein the light guide plate forms an image accompanied by a change that is made in a direction from the half mirror toward the mirror in a space different from the light exit surface by light emitted from the light exit surface.

2. The display device according to claim 1, wherein when a distance between the half mirror and the mirror is L1, and an entire length of an image formed by the light guide plate in a direction from the half mirror toward the mirror is L2, L2 is larger than twice L1.

3. The display device according to claim 1, wherein when a distance between the half mirror and the mirror is L1, and an entire length of an image formed by the light guide plate in a direction in which the mirror is disposed is L2, L2 is twice L1 or less.

4. The display device according to claim 1, wherein there is a difference in an image formed by the light guide plate between an image formed on a side of the half mirror with respect to the light exit surface and an image formed on a side of the mirror with respect to the light exit surface.

5. The display device according to claim 1, wherein an image formed by the light guide plate differs depending on a direction in which the image is formed.

6. The display device according to claim 1, wherein images formed by the light guide plate have a shape of convergence on a side where the mirror is disposed with respect to the light guide plate.

7. The display device according to claim 1, wherein the mirror and the half mirror are longer than a region where the optical path changing unit is provided in a direction parallel to the light guide plate.

8. The display device according to claim 7, wherein the mirror and the half mirror are longer than the light guide plate in the direction parallel to the light guide plate.

9. The display device according to claim 1, wherein one of the half mirror and the mirror is formed on a front surface of the light guide plate.

10. The display device according to claim 1, wherein the light guide plate, the half mirror, and the mirror are curved so as to be convex toward a side where the image is observed.

11. The display device according to claim 1, wherein a transmittance of the half mirror is 80% or less.

12. The display device according to claim 1, further comprising a cover disposed on a side of the half mirror opposite to the light guide plate,
wherein a transmittance of the half mirror is lower than a transmittance of the cover.

13. The display device according to claim 2, wherein one of the half mirror and the mirror is formed on a front surface of the light guide plate.

14. The display device according to claim 3, wherein one of the half mirror and the mirror is formed on a front surface of the light guide plate.

15. The display device according to claim 4, wherein one of the half mirror and the mirror is formed on a front surface of the light guide plate.

16. The display device according to claim 5, wherein one of the half mirror and the mirror is formed on a front surface of the light guide plate.

17. The display device according to claim 6, wherein one of the half mirror and the mirror is formed on a front surface of the light guide plate.

18. The display device according to claim 7, wherein one of the half mirror and the mirror is formed on a front surface of the light guide plate.

19. The display device according to claim 8, wherein one of the half mirror and the mirror is formed on a front surface of the light guide plate.

20. The display device according to claim 2, wherein the light guide plate, the half mirror, and the mirror are curved so as to be convex toward a side where the image is observed.
